(19) United States
(12) Patent Application Publication
(10) Pub. No.: US 2020/0039261 A1
(43) Pub. Date: Feb. 6, 2020

(54) BELT CLEANING DEVICE AND INK-JET IMAGE FORMING APPARATUS

(71) Applicant: Konica Minolta, Inc., Tokyo (JP)

(72) Inventor: Yutaka HOKAZONO, Tokyo (JP)

(21) Appl. No.: 16/506,282

(22) Filed: Jul. 9, 2019

(30) Foreign Application Priority Data
Aug. 3, 2018 (JP) 2018-146559

(51) Int. Cl. B41J 29/17; B41J 11/00

(52) U.S. Cl. CPC B41J 29/17; B41J 11/007; B41J 11/0015

(57) ABSTRACT

A belt cleaning device for cleaning of an endless conveyance belt configured to convey a recording medium, the belt cleaning device includes: a cleaning blade configured to remove washing liquid supplied to the conveyance belt by making contact with the conveyance belt; and an air jetting part configured to jet air for removing the washing liquid that has passed through the cleaning blade without being removed by the cleaning blade at a position downstream of the cleaning blade in a conveyance direction of the conveyance belt.

### CROSS REFERENCE TO RELATED APPLICATIONS

The entire disclosure of Japanese Patent Application No. 2018-146559 filed on Aug. 3, 2018 is incorporated herein by reference in its entirety.

### BACKGROUND

### Technological Field

The present invention relates to a belt cleaning device and an ink jet image forming apparatus.

### Description of Related Art

In recent years, as recording apparatuses for recording high-definition images on various recording medium such as paper and fabric, ink-jet image forming apparatuses are widely accepted. In particular, in the case where a recording medium of a long web form is used, a belt conveyance device provided with an endless conveyance belt is used to convey the recording medium by bringing the medium into intimate contact with the conveyance belt (e.g. Japanese Patent Application Laid-Open No. 2012-116617 (hereinafter referred to as PTL 1)).

In some situation, contamination materials such as paper dust, threads, and preprocessing agents may adhere to the conveyance belt depending on the type of the recording medium, and such materials may mix with ink on the conveyance belt and adhere thereto as foreign matters. When such foreign matters attached on the conveyance belt is left, the foreign matters may cause a problem of reduction in product quality by adhering to the rear surface of the recording medium supplied anew, and a problem of destabilization of the conveyance of the recording medium by affecting the friction between the conveyance belt and the recording medium.

To solve such a problem, normally, an ink-jet image forming apparatus including the above-mentioned conveyance belt is provided with a belt cleaning device for cleaning foreign matters attached on the surface of the conveyance belt.

Regarding belt cleaning devices, for example, the technique disclosed in PTL 1 includes a configuration in which washing liquid is supplied to the surface of the conveyance belt to wash away foreign matters attached on the conveyance belt, and the washing liquid is scraped by a cleaning blade (scraping blade) that makes contact with the conveyance belt surface.

In the configuration disclosed in PTL 1, when damages (irregularities) are left on the surface of the conveyance belt, the cleaning blade cannot completely eliminate washing liquid attached in the irregularities, and liquid may pass through cleaning blade as residual liquid. When such residual liquid is left, the residual liquid may adhere to the rear surface of recording medium P supplied anew, and the product quality may be reduced due to image smear and the like.

To solve such a problem, it is conceivable to replace the cleaning blade with a pressing-air jetting blade (i.e., a non-contact blade that does not make contact with the conveyance belt). With such a configuration, however, the jetted pressing air strikes the washing liquid, and consequently the washing liquid may float inside the apparatus in the form of a large amount of fog (mist). If such floating mist of washing liquid is left, a malfunction of electronic components such as a sensor in the apparatus may occur, or smudges, rusts and the like on components in the apparatus may result.

### SUMMARY

An object of the present invention is to provide a cleaning device and an ink jet image forming apparatus capable of achieving both removal of the washing liquid remaining on the conveyance belt and reduction of vaporization of the washing liquid belt.

To achieve the abovementioned object, a belt cleaning device reflecting one aspect of the present invention includes is configured to for cleaning of an endless conveyance belt configured to convey a recording medium, the belt cleaning device including: a cleaning blade configured to remove washing liquid supplied to the conveyance belt by making contact with the conveyance belt; and an air jetting part configured to jet air for removing the washing liquid that has passed through the cleaning blade without being removed by the cleaning blade at a position downstream of the cleaning blade in a conveyance direction of the conveyance belt.

To achieve the abovementioned object, an ink-jet image forming apparatus reflecting one aspect of the present invention includes: the belt cleaning device; and an ink jet head configured to discharge ink to the recording medium conveyed by the conveyance belt.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic configuration diagram of an ink-jet image forming apparatus of a present embodiment;

FIG. 2A and FIG. 2B illustrate a scar left on a conveyance belt and an inclination angle of an air supply part and the like;

FIG. 3 illustrates another exemplary configuration of the air supply part; and

FIG. 4 illustrates another arrangement example of the air supply part.

### DETAILED DESCRIPTION OF EMBODIMENTS

Hereinafter, one or more embodiments of the present invention will be described with reference to the drawings. However, the scope of the invention is not limited to the disclosed embodiments.

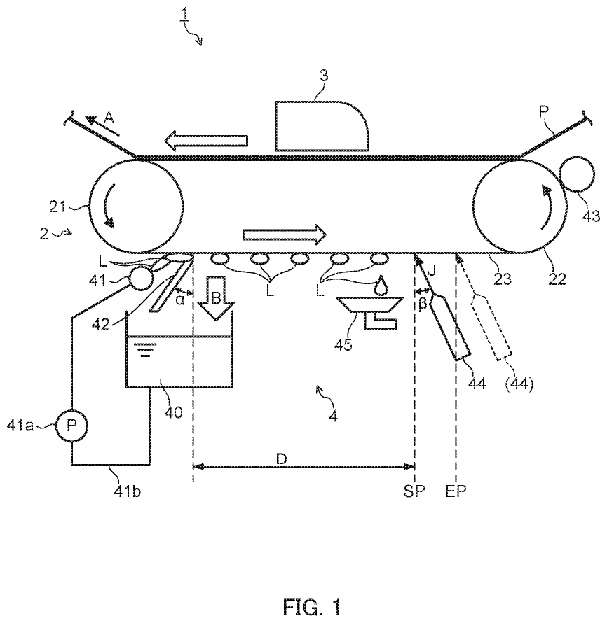

FIG. 1 is a schematic configuration diagram illustrating an example of image recording apparatus 1 as an ink-jet image forming apparatus according to the present invention. Image recording apparatus 1 includes belt conveyance device 2, recording head 3, and belt cleaning device 4.

In belt conveyance device 2, endless conveyance belt 23 having a predetermined width is disposed in a stretched state around a plurality of (two, in the example illustrated in the drawing) rollers 21 and 22 disposed in parallel with each other with a predetermined distance therebetween. The top surface of conveyance belt 23 disposed around rollers 21 and 22 serves as a placing surface on which to intimately place recording medium P. Note that an adhesive called Jibari (base material) is applied on the surface of conveyance belt 23 for intimate contact of recording medium P being conveyed with the top surface of conveyance belt 23. In addition, of the two rollers, roller 21 is a driving roller driven by a sub scanning motor not illustrated, and roller 22 is a slave roller.

In belt conveyance device 2, when driving roller 21 is driven by the sub scanning motor into rotation in a counter clockwise direction (see the arrow) in FIG. 1 at a predetermined speed, conveyance belt 23 disposed around driving roller 21 and slave roller 22 is rotated. With such an operation, recording medium P placed on the top surface of conveyance belt 23 is conveyed in the direction of arrow A, which is a sub scanning direction, illustrated in FIG. 1.

Recording medium P may be any recording medium typically used for ink jet recording, such as paper, fabric, plastic film, and glass plate, for example. Recording medium P may have a sheet form cut in a predetermined size, or an elongated form that is continuously pulled from a roll wound in a roll form.

Recording head 3 is an ink jet head disposed above the surface of conveyance belt 23 on which recording medium P is placed with a predetermined distance therebetween, and is configured to discharge ink drops from multiple nozzles provided in its bottom surface so as to record a desired image on recording medium P conveyed by the rotational movement of conveyance belt 23.

In the present embodiment, recording head 3 is a shuttle-recording head mounted in a carriage not illustrated and configured to move back and forth in the main scanning direction orthogonal to a conveyance direction of recording medium P conveyed intermittently. In this case, during recording, driving of the sub scanning motor and driving roller 21 is controlled such that conveyance belt 23 performs an intermittent operation of repeating a standby state and a driving state. In addition, the conveyance pitch of the intermittent operation may be set to any value equal to or smaller than the head length of recording head 3 (the length from a first ink discharging nozzle to the Nth ink discharging nozzle arranged in the conveyance direction (not illustrated)).

Alternatively, recording head 3 may be a linear recording head fixed across the width direction of conveyance belt 23 and records an image by discharging ink drops onto continuously conveyed recording medium P. In this case, during recording, the driving of the sub scanning motor and driving roller 21 is controlled such that conveyance belt 23 continuously moves (rotates).

Belt cleaning device 4 is provided in belt conveyance device 2, and is provided below the conveyance region of recording medium P in the present embodiment. In this belt cleaning device 4, a plurality of cleaning units are sequentially provided along the movement direction of conveyance belt 23. In the example illustrated in FIG. 1, as the cleaning units, water sprinkling pipe 41, scraping blade 42, air jetting part 44, and liquid absorption roller 43 are sequentially provided.

Water sprinkling pipe 41 has a function of a washing liquid supply section that supplies washing liquid to conveyance belt 23. Water sprinkling pipe 41 is laid over the whole width of conveyance belt 23, and multiple nozzles (not illustrated) are arranged along the longitudinal direction at a portion opposite to the surface of conveyance belt 23. When water sprinkling pump 41a is driven, washing liquid in cleaning tub 40 is supplied to water sprinkling pipe 41 via water sprinkling tube 41b, and foreign matters attached on the surface of conveyance belt 23 is washed away by jetting the supplied washing liquid toward the surface of conveyance belt 23 from the nozzle.

Scraping blade 42 is disposed downstream of water sprinkling pipe 41 in the conveyance direction of conveyance belt 23, and has a function of a cleaning blade that removes washing liquid and the like on conveyance belt 23 by making contact with conveyance belt 23. For example, scraping blade 42 is formed in a plate shape with an elastic material such as rubber, and is laid over the whole width of conveyance belt 23. Scraping blade 42 is disposed on the downstream side of water sprinkling pump 41a in the conveyance direction so as to be tilted to the conveyance direction such that its end makes contact with the surface of conveyance belt 23 at all times.

Along with the rotational movement of conveyance belt 23, scraping blade 42 scrapes and eliminates the washing liquid containing contamination materials attached on the surface of conveyance belt 23 from water sprinkling pipe 41. The eliminated washing liquid flows down the surface of scraping blade 42 so as to be housed into cleaning tub 40.

Note that the inclination angle of scraping blade 42, and configurations of air jetting part 44 and liquid absorption roller 43 are described later.

Incidentally, in the above-described ink jet image forming apparatus, when a scar (irregularity) is left on the surface of conveyance belt 23, scraping blade 42 cannot completely eliminate the washing liquid attached in the irregularities, and the liquid may pass through scraping blade as residual liquid 42. When such residual liquid is left, the residual liquid may adhere to the rear surface of recording medium P supplied anew, and the product quality may be reduced due to image smear and the like.

In particular, in an apparatus in which recording medium P on conveyance belt 23 is intermittently conveyed as in the present embodiment, a scar (irregularity) such as a deep groove may be left in the surface (Jibari (base material)) of the conveyance belt by the end of scraping blade 42 in the intermittent operation of conveyance belt 23 (repeat of the standby state and the driving state).

To solve such a problem, it is conceivable to replace scraping blade 42 with a non-contact configuration that does not make contact with conveyance belt 23, such as a configuration of a type that jets pressing air, for example. With such a configuration, the whole washing liquid supplied (attached) to conveyance belt 23 from water sprinkling pipe 41 is removed by jetting pressing air. As a result, the jetted pressing air strikes the washing liquid on conveyance belt 23, and consequently the washing liquid may float inside the apparatus in the form of a large amount of fog (mist). If such floating mist of washing liquid is left, a malfunction of electronic components such as a sensor in the apparatus may occur, or smudges, rusts and the like on components in the apparatus may result.

In view of this, in the present embodiment, air jetting part 44, which jets air for removing washing liquid past scraping blade 42, is provided downstream of scraping blade 42 in the conveyance direction below the conveyance region of recording medium P as illustrated in FIG. 1.

Specifically, in the present embodiment, the majority of the washing liquid attached on the surface of conveyance belt 23 from water sprinkling pipe 41 is removed by scraping blade 42, and the washing liquid that has been that has not been removed (i.e., residual liquid that has not been scraped) due to the above-mentioned irregularities on conveyance belt 23 is removed by the air jetting. With this configuration, the amount of washing liquid used for removal by air jetting part 44 can be reduced in advance, and it is possible to achieve both removal of the washing liquid remaining on conveyance belt 23, and reduction of vaporization of the washing liquid.

A configuration of air jetting part 44 is described in detail below. In the present embodiment, a so-called “air knife”, which is a device for jetting pressing air in the form of a thin layer air stream, is used as air jetting part 44. Air jetting part 44 is laid over the whole width of conveyance belt 23, and a jetting port that jets a thin layer air stream (see arrow J in FIG. 1) is disposed at the end facing the surface of conveyance belt 23.

Although not illustrated in the drawing, a heat source (heater), an air pump, and an air supply tube are provided on the base end side of air jetting part 44. In the present embodiment, air jetting part 44 is disposed so as to jet a thin layer air stream in a direction tilted in a direction opposite to the conveyance direction of conveyance belt 23 (see angle β in FIG. 1). In addition, in this example, air (pressing air) supplied from the air pump through the air supply tube is heated by a heater, and this heated pressing air (heating air) is jetted from the jetting port of air jetting part 44 as a thin layer air stream toward the surface of conveyance belt 23.

Air jetting part 44 jets the heating air from the jetting port toward the surface of conveyance belt 23 to thereby facilitate evaporation of the washing liquid (droplet L) remaining on the surface of conveyance belt 23, thus suppressing vaporization (aerification) of the washing liquid and scattering of the mist. In addition, of the washing liquid remaining on the surface of conveyance belt 23, droplet L that has been blown off by heating air drops into collection tub 45 provided at a corresponding position, and is collected to cleaning tub 40 through the collection tub 45, for example. In this manner, in the present embodiment, collection tub 45 is disposed at a position corresponding to a region of conveyance belt 23 to which air is jetted from air jetting part 44, and thus the droplet L and vaporized washing liquid can be effectively collected.

In addition, in the present embodiment, liquid absorption roller 43 is disposed at a position downstream of air jetting part 44 in the conveyance direction below the conveyance region of recording medium P (in this example, a position opposite to slave roller 22). Liquid absorption roller 43 is formed in a roller shape with a liquid-absorbent porous member such as sponge wound around a rotation shaft laid over the whole width of conveyance belt 23. Liquid absorption roller 43 functions as a liquid absorption part that absorbs washing liquid remaining on conveyance belt 23.

The surface of liquid absorption roller 43 is in contact with the surface of conveyance belt 23 at all times. Liquid absorption roller 43 is rotated by the drive motor not illustrated in the drawing in the same direction as the movement direction of conveyance belt 23 at a predetermined speed, or is rotated along with the rotational movement of conveyance belt 23 in a slave manner to thereby remove the washing liquid containing contamination materials attached on the surface of conveyance belt 23 by absorbing and wiping the washing liquid.

In the present embodiment, liquid absorption roller 43 functions as a spare residual liquid removal means for the case where removal of residual liquid by air jetting part 44 is failed due to a malfunction of air jetting part 44, for example. In addition, even in a configuration in which scraping blade 42 can be moved out from the conveyance belt as described later, liquid absorption roller 43 functions as a spare residual liquid removal means for residual liquid that has not been removed by air jetting part 44. Further, liquid absorption roller 43 is disposed on the upstream side in the proximity of recording medium P being conveyed, and thus, in case of generation of mist of the washing liquid in the apparatus, liquid absorption roller 43 plays a role of protecting recording medium P from adhesion of the mist.

In the present embodiment, a configuration of a contact type using liquid absorption roller 43 that makes contact with conveyance belt 23 is adopted as an example of the liquid absorption part for absorbing the washing liquid remaining on conveyance belt 23. As an example of the liquid absorption part, it is also possible to adopt a configuration of a non-contact type in which, for example, an air absorption device not illustrated is used to absorb the washing liquid remaining on conveyance belt 23.

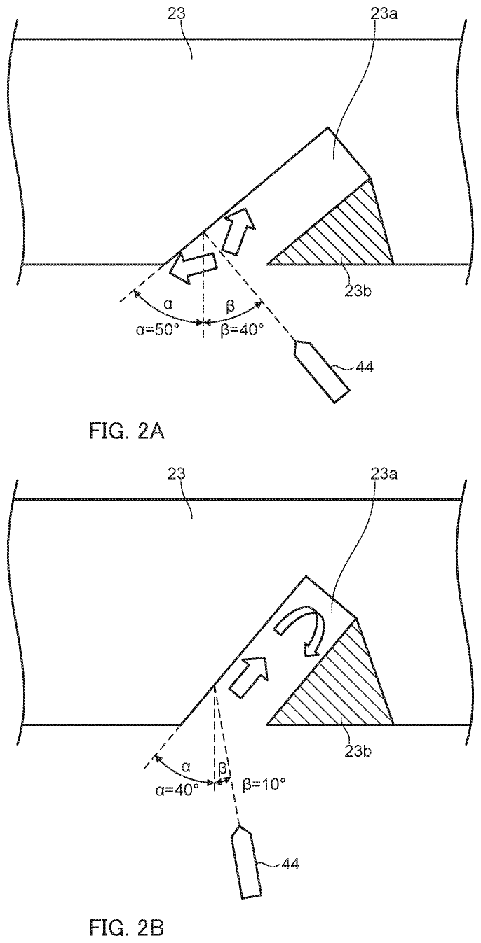

Next, with reference to FIG. 2 (FIG. 2A and FIG. 2B), preferable inclination angles of scraping blade 42 and air jetting part 44 and the like are described. In FIG. 2A and FIG. 2B, a represents an inclination angle (the contact angle) of the end of scraping blade 42 that makes contact with conveyance belt 23, and β represents an inclination angle of air jetting part 44 with respect to conveyance belt 23.

As described above, in the present embodiment, recording head 3 is a shuttle-recording head that moves back and forth in a main scanning direction orthogonal to the conveyance direction of intermittently conveyed recording medium P. In addition, conveyance belt 23 of belt conveyance device 2 is driven into intermittent motion at a preliminarily set conveyance pitch for the purpose of intermittently conveying recording medium P facing recording head 3.

In such a drive system, tilted groove (recess) 23a may be formed in some situation as illustrated in FIG. 2A and FIG. 2B when the surface of conveyance belt 23 is cut by the end of scraping blade 42 at the time when conveyance belt 23 is temporarily stopped. Here, the inclination angle of groove (recess) 23a is an approximated value of the contact angle α of scraping blade 42 with respect to conveyance belt 23.

FIG. 2A schematically illustrates a flow of air jetted from air jetting part 44 in a specific example (comparative example) in which the contact angle α of scraping blade 42 is 50° and inclination angle β of air jetting part 44 is 40°.

As illustrated in FIG. 2A, in the case where α+β=90°, the air jetted from air jetting part 44 strikes the inner wall of groove (recess) 23a at approximately 90°, and its air flow is separated into two parts as two arrows indicate in FIG. 2A. As a result, the air flowing toward the depth side of groove (recess) 23a (in FIG. 2A, the air indicated by the upper right arrow) is weakened, and the droplet attached on the depth side of groove (recess) 23a (in particular, at the deepest portion) may not be removed.

Likewise, although not illustrated in the drawings, in the case where α+β is greater than 90°, the flow of the air jetted from air jetting part 44 is separated into two parts, and the flow of the air flowing in the direction opposite the depth side of groove (recess) 23a (in FIG. 2A, the air indicated by left lower arrow) is stronger than the air flowing toward the depth side of groove (recess) 23a. As a result, the flow of the air flowing toward the depth side of groove (recess) 23a (in FIG. 2A, the air indicated by right upward arrow) is further weakened, and the droplet attached on the depth side of groove (recess) 23a may not be removed with a higher probability.

FIG. 2B schematically illustrates a flow of air jetted from air jetting part 44 in a specific example of the present embodiment in which contact angle α of scraping blade 42 is 40°, and inclination angle β of air jetting part 44 is 10°.

As illustrated in FIG. 2B, in the case where α+β is smaller than 90° (in this example, 50°), the flow of the air jetted from air jetting part 44 is not separated unlike the above-mentioned cases, and the air flow reaches the deepest portion of groove (recess) 23a and turns at the deepest portion as two arrows indicate in FIG. 2B while the intensity of the air flow is maintained. As a result, the droplet attached on the deepest portion of groove (recess) 23a can be removed.

Note that, in FIG. 2A and FIG. 2B, adjacent region 23b hatched on the right side of groove (recess) 23a may be cut by the end of scraping blade 42 together with groove (recess) 23a at the time when conveyance belt 23 is temporarily stopped. The above-described suitable value of α+β applies also to this case, and it is preferable to set α+β to 90° or smaller.

Additionally, the contact angle α of scraping blade 42 varies in accordance with the state of the apparatus (typically, a stopped state, a temporarily stopped state, or a moving state of conveyance belt 23) and thus has a certain range. For example, the contact angle α varies in the range of 20° to 40°. Typically, the above-described groove (recess) 23a is formed when the contact angle of scraping blade 42 is large, and therefore it is preferable to set α to a maximum value (in the above-mentioned example, 40°).

On the other hand, in the present embodiment, the inclination angle β of air jetting part 44 with respect to conveyance belt 23 is fixed (at 10° in this example) with almost no variation. In addition, various experiments conducted by the present inventors revealed that a favorable result is achieved when the inclination angle β of air jetting part 44 with respect to conveyance belt 23 is set to a value, i.e. an inclination angle, smaller than that of the contact angle α of scraping blade 42.

Note that, in view of removing residual liquid in groove (recess) 23a as illustrated in FIG. 2A and FIG. 2B, it may be conceivable to tilt air jetting part 44 to the conveyance direction of conveyance belt 23 as with scraping blade 42. With such a configuration, however, the residual liquid (droplet L) on which the pressing air is jetted may go to the downstream side, causing the above-described vaporization. Accordingly, preferably, air jetting part 44 is disposed so as to jet pressing air in a direction tilted in the direction opposite to the conveyance direction of conveyance belt 23.

In addition, the above-described groove (recess) 23a can be formed not only when recording medium P is intermittently conveyed by conveyance belt 23, but also in various cases such as when conveyance belt 23 is driven at constant speed, and when a standby state is established with scraping blade 42 making contact with conveyance belt 23.

Normally, the feeding amount (conveyance pitch) per intermittent driving of conveyance belt 23 can be changed for each printing job (i.e., in accordance with recording medium P) with the nozzle length of recording head 3 as the maximum feeding amount.

In view of this, to effectively remove the droplet attached on the deepest portion of groove (recess) 23a, it is preferable to dispose air jetting part 44 as described below at a position along the conveyance direction of conveyance belt 23.

With reference to FIG. 1 again, it is assumed to set an intersection point of an a straight line extended from the end of air jetting part 44 along the air jetting direction, and the surface of conveyance belt 23. This intersection point corresponds to the point where the air jetted from air jetting part 44 directly hits conveyance belt 23. Here, when a start point (“SP” in FIG. 1) is set at a position separated from the contact point of scraping blade 42 and conveyance belt 23 by an integer multiple of the maximum feeding amount (nozzle length) on the downstream side of the contact point, the intersection point is set in an air effective region extending from start point SP to a point (“EP” in FIG. 1) on the downstream side. Here, the air effective region is a region where air (pressing air) jetted from air jetting part 44 to stopped conveyance belt 23 can reach the deepest portion of groove (recess) 23a (see FIG. 2B). Note that the air effective region may differ depending on the intensity of the air jetted from air jetting part 44, the depth of groove (23a), and/or the inclination angles α and β.

In general, it is preferable to set distance D, from the end of scraping blade 42 to the hitting position of air jetted from air jetting part 44, to a value between a position obtained by adding length obtained by multiplying the movement amount of conveyance belt 23 of one driving of the intermittent operation by an integer to the end of scraping blade 42 on the downstream side in the conveyance direction, and a position obtained by further adding the air effective region length on the downstream side.

With such a configuration, in the case where intermittently driven conveyance belt 23 is stopped (standby state), groove (recess) 23a stays in the air effective region for a certain period, and thus the droplet attached on the deepest portion of groove (recess) 23a can be more surely removed.

Note that, as an additional configuration, air jetting part 44 may be moved to a suitable position in accordance with the setting value of the feeding amount (conveyance pitch) of per intermittent operation. In this case, for example, a driving mechanism such as a solenoid and the like for moving air jetting part 44 back and forth in the horizontal direction in FIG. 1 is provided. When conveyance belt 23 is intermittently driven, the driving mechanism is driven by a control part not illustrated in the drawing to adjust the position (distance D in FIG. 1) of air jetting part 44 such that jetted air is set at a position where the air is most effectively introduced to groove (recess) 23a.

As described above, in the present embodiment, air jetting part 44 of non-contact type is provided on the downstream side of scraping blade 42 (contact type cleaning blade), and air jetting part 44 jets air at a suitable angle in accordance with the inclination angle of scraping blade 42. With this configuration, washing liquid remaining in a recess in the surface of conveyance belt 23 (in particular, in a deep groove) can be effectively removed while suppressing vaporization of the washing liquid.

Modifications of the above-described configurations are described below.

In the embodiment, as an exemplary configuration, scraping blade 42 is in contact with conveyance belt 23 at all times. Alternatively, it is possible to adopt an exemplary configuration in which, when conveyance belt 23 is intermittently driven, scraping blade 42 moves out from conveyance belt 23. In this case, for example, a driving mechanism such as a solenoid for moving scraping blade 42 back and forth in the vertical direction is provided, and the solenoid or the like is driven by a control part not illustrated in the drawing so as to move scraping blade 42 downward from conveyance belt 23 when conveyance belt 23 is intermittently driven (see arrow B in FIG. 1). With such a control, the possibility of formation of scars (recesses) in the surface of conveyance belt 23 with scraping blade 42 is suppressed, and in turn, the problems of leaving washing liquid in the recess is eased.

On the other hand, when scraping blade 42 is moved downward of conveyance belt 23, the amount of washing liquid that passes through scraping blade 42 increases, and the problem of vaporization of the washing liquid may occur at the time of jetting pressing air from air jetting part 44. Accordingly, when the configuration in which scraping blade 42 is moved out from conveyance belt 23 is adopted, it is preferable to alternatively or additionally dispose liquid absorption roller 43 at a position downstream of scraping blade 42 and upstream of air jetting part 44. With this configuration, the amount of the residual liquid generated upstream of air jetting part 44 can be reduced in advance while suppressing scars (recesses) left in the surface of conveyance belt 23, and it is thus possible to achieve both removal of the washing liquid remaining on conveyance belt 23, and reduction of vaporization of the washing liquid.

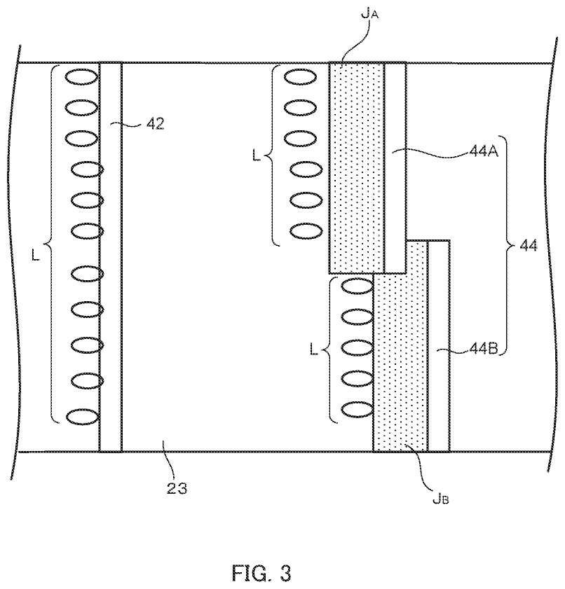

In the embodiment, one air jetting part 44 is provided over the whole width of conveyance belt 23. Alternatively, as another example, a plurality of air jetting parts 44 partially overlapping each other in the width direction may be disposed in a step form or a staggered form along the width direction of conveyance belt 23 as illustrated in FIG. 3. This layout is expressed to as “stagger” below.

In the example illustrated in FIG. 3, as air jetting part 44, two parts, air jetting part 44A and air jetting part 44B, are provided such that thin layer air stream J_{A} jetted from air jetting part 44A and thin layer air stream J_{B} jetted from air jetting part 44B partially overlap at a center in the width direction of conveyance belt 23.

That is, the slender jetting port of air jetting part 44 extends along the width of conveyance belt 23, and therefore the possibility of warp (deflection) of the jetting port increases as the width of conveyance belt 23 increases. As a result, as the width of conveyance belt 23 increases, the management of component accuracy of air jetting part 44 and/or the management of the gap between the jetting port of air jetting part 44 and conveyance belt 23 becomes difficult. In view of this, especially in the case where conveyance belt 23 is wide, it is preferable to provide a plurality of air jetting parts 44 in a staggered manner (see FIG. 3). With this configuration, warp (deflection) of air jetting part 44 can be reduced, and the component accuracy and the gap can be easily managed, and as a result, the liquid remaining in the recess (groove section) of conveyance belt 23 can be more surely removed.

Note that, from the same view point, a plurality of scraping blades 42 may be disposed in a staggered manner. When a plurality of scraping blades 42 are disposed in a staggered manner, washing liquid may enter from the joint portion, and the entered washing liquid may leak to the downstream side. As such, the configuration in which scraping blades 42 (contact blades) are disposed in a staggered manner may not be preferable. In addition, for example, since scraping blade 42 (contact blade) has a simple configuration composed of a single rubber plate, the component accuracy can be easily ensured and there is no welding warp in comparison with air jetting part 44, and therefore, the single configuration is preferable in consideration of the entry of washing liquid from the joint portion.

In contrast, air jetting part 44 is configured to use pressing air blow away the washing liquid to the upstream side of the air effective region of air jetting part 44 without making contact with conveyance belt 23. Therefore, air jetting part 44 can prevent the entry of washing liquid from the joint portion and can be arranged in a staggered manner.

Note that, in the case where conveyance belt 23 has a large width for example, a single scraping blade 42 may not ensure component accuracy, and in view of this scraping blade 42 may better be divided and arranged in a staggered manner. In this case, it is preferable to set the positions (phases) in the width direction of the joint portion of staggered scraping blades 42 and the joint portion of staggered air jetting parts 44A and 44B at positions different from each other. To be more specific, the joint portion of staggered air jetting parts 44A and 44B corresponds to the end portions of air jetting parts 44A and 44B, and therefore the intensity of the pressing air at the joint portion may be weaker than the other portions. In this case, by setting the positions (phases) in the width direction of the joint portion of staggered scraping blades 42 and the joint portion of staggered air jetting parts 44A and 44B at positions different from each other, their weak portions can be made up, and as a result remaining liquid in groove (recess) 23a of conveyance belt 23 can be more surely removed.

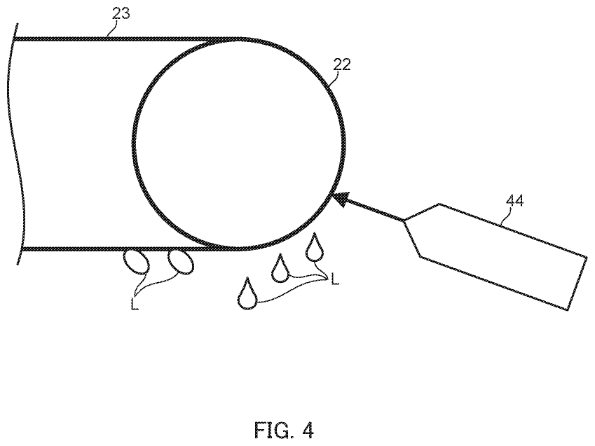

In the embodiment, air jetting part 44 is provided on the bottom surface side of conveyance belt 23. Alternatively, air jetting part 44 may be provided near slave roller 22 as illustrated in FIG. 4.

Although embodiments of the present invention have been described and illustrated in detail, the disclosed embodiments are made for purpose of illustration and example only and not limitation. The scope of the present invention should be interpreted by terms of the appended claims

What is claimed is:

1. A belt cleaning device for cleaning of an endless conveyance belt configured to convey a recording medium, the belt cleaning device comprising:
a cleaning blade configured to remove washing liquid supplied to the conveyance belt by making contact with the conveyance belt; and
an air jetting part configured to jet air for removing the washing liquid that has passed through the cleaning blade without being removed by the cleaning blade at a position downstream of the cleaning blade in a conveyance direction of the conveyance belt.

2. The belt cleaning device according to claim 1, wherein
the cleaning blade is tilted to the conveyance direction and makes contact with the conveyance belt; and
the air jetting part jets the air in a direction tilted to a direction opposite to the conveyance direction.

3. The belt cleaning device according to claim 1, wherein the following Expression 1 is satisfied
α+β<90° (Expression 1)
where α represents a contact angle of the cleaning blade to the conveyance belt, and β represents an air jetting angle of the air jetting part to the conveyance belt.

4. The belt cleaning device according to claim 1, wherein
the conveyance belt is driven to operate an intermittent operation of repeating a standby state and a driving state; and
the air jetting part is disposed at a position where the air is allowed to be introduced to a recess of the conveyance belt formed by the cleaning blade in the standby state.

5. The belt cleaning device according to claim 4, wherein an intersection point of a line of a jetting direction of the air jetted from the air jetting part and the surface of the conveyance belt is located between a first position and a second position, the first position being located downstream of an end of the cleaning blade in the conveyance direction, the first position being separated from the end of the cleaning blade by a length obtained by multiplying, by an integer, a movement amount of the conveyance belt of each driving state in the intermittent operation, the second position being located downstream of the first position, the second position being separated from the first position by a length of an air effective region.

6. The belt cleaning device according to claim 1, wherein
a plurality of the air jetting parts are provided along a width direction of the conveyance belt; and
the air jetted from the plurality of the air jetting parts partially overlap in the width direction of the conveyance belt.

7. The belt cleaning device according to claim 1, further comprising a collection part configured to collect the washing liquid that has dropped from the conveyance belt due to jetting of the air.

8. The belt cleaning device according to claim 1, wherein the air jetting part jets the air that is heated.

9. The belt cleaning device according to claim 4, wherein when the intermittent operation is performed, the cleaning blade moves out from the conveyance belt.

10. The belt cleaning device according to claim 1 further comprising a liquid absorption part configured to absorb the washing liquid remaining on the conveyance belt at a position downstream of the cleaning blade in the conveyance direction.

11. The belt cleaning device according to claim 10, wherein the liquid absorption part is disposed downstream of the air jetting part in the conveyance direction.

12. The belt cleaning device according to claim 6, wherein
a plurality of the cleaning blades are disposed along the width direction of the conveyance belt such that the plurality of the cleaning blades are partially overlap each other; and
a position of a partially overlapping portion of the plurality of the cleaning blades in the width direction of the conveyance belt is different from a partially overlapping portion of the air in the width direction of the conveyance belt.

13. An ink jet image forming apparatus comprising:
the belt cleaning device according to claim 1; and
an ink jet head configured to discharge ink to the recording medium conveyed by the conveyance belt.
